(19) United States
(12) Patent Application Publication
(10) Pub. No.: US 2014/0042152 A1
(43) Pub. Date: Feb. 13, 2014

(54) VARIABLE FREQUENCY MICROWAVE DEVICE AND METHOD FOR RECTIFYING WAFER WARPAGE

(71) Applicants: Yen-Chang HU, Taichung City (TW); Ching-Wen Hsiao, Hsinchu City (TW); Chen-Shien CHEN, Hsinchu County (TW)

(72) Inventors: Yen-Chang HU, Taichung City (TW); Ching-Wen Hsiao, Hsinchu City (TW); Chen-Shien CHEN, Hsinchu County (TW)

(73) Assignee: Taiwan Semiconductor Manufacturing Company, Ltd., Hsinchu (TW)

(21) Appl. No.: 13/569,468

(22) Filed: Aug. 8, 2012

(51) Int. Cl. H05B 6/64

(52) U.S. Cl. 219/679

(57) ABSTRACT

A variable frequency microwave (VFM) device and a method for rectifying wafer warpage are provided. The variable frequency microwave (VFM) device includes a heater installed in the top wall of the chamber; and a cooler installed in proximity to the bottom wall of the chamber.

### FIELD

The present disclosure relates to a device and a method using the same for rectifying wafer warpage. In particular, it relates to a variable frequency microwave (VFM) device and a method for rectifying the wafer warpage.

### BACKGROUND

Wafer warpage commonly occurs in a microelectronic or semiconductor fabricating process. The warpage degrades device performance, reliability and line width control in various processing steps. Therefore, early detection and precise rectification of the wafer warpage can minimize cost and processing time, and ensure quality of semiconductor products as desired.

In semiconductor processing, when using lower cure temperature materials, coefficients of thermal expansion of molding compounds and silicon cause significant wafer bow, handling problems, and longer curing time, thus resulting in low throughput, as measured in wafers per hour (WPH).

Thus, there is a need to solve the above-mentioned problems.

### DESCRIPTION OF THE DRAWINGS

For a more complete understanding of the present embodiments, and the advantages thereof, reference is now made to the following descriptions taken in conjunction with the accompanying drawings, in which:

FIG. 1 is a schematic diagram illustrating an embodiment of the VFM device in accordance with the present disclosure, and

FIG. 2 is a schematic diagram illustrating a method for rectifying wafer warpage in accordance with the present disclosure.

### DETAILED DESCRIPTION

The present disclosure will be described with respect to particular embodiments and with reference to certain drawings, but the disclosure is not limited thereto but is only limited by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice.

Furthermore, the terms first, second and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments described herein are capable of operation in other orientations than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B.

Reference throughout this specification to “one embodiment” or “an embodiment” means that a particular feature, structure or characteristic described in connection with the embodiment is included in at least one embodiment. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the description of exemplary embodiments, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed disclosure requires more features than are expressly recited in each claim. Rather, as the following claims reflect, inventive aspects lie in less than all features of a single foregoing disclosed embodiment.

Furthermore, while some embodiments described herein include some but not other features included in other embodiments, combinations of features of different embodiments are meant to be within the scope of the disclosure, and form different embodiments, as would be understood by those in the art. For example, in the following claims, any of the claimed embodiments can be used in any combination.

In the description provided herein, numerous specific details are set forth. However, it is understood that embodiments may be practiced without these specific details. In other instances, well-known methods, structures and techniques have not been shown in detail in order not to obscure an understanding of this description.

The disclosure will now be described by a detailed description of several embodiments. It is clear that other embodiments can be configured according to the knowledge of persons skilled in the art without departing from the true technical teaching of the present disclosure, the claimed disclosure being limited only by the terms of the appended claims.

Variable frequency microwave (VFM) devices, used in packaging procedures of the semiconductor industry and the electronic components industry for example, offer controlled and uniform distribution of microwave energy for a broad range of thermal applications, so that wafer warpage is cured and finally the dies are packaged with polymeric adhesives or solders. With a high microwave power and a high temperature supply, a large number of dies/electronic components packaged within molding materials (or polymeric adhesives) on a carrier are cured for warpage and further processing, and such a VFM curing process is useful for BGA (Ball Grid Array), eWLB (embedded wafer-level BGA), chip scaled packaging, wafer level chip scaled packaging (WLCSP), fan-out WLCSP processes, and on the like. Nevertheless, wafer warpage still exists, or worsens, after the conventional VFM rectification process, and rectification on the warped wafers is essential.

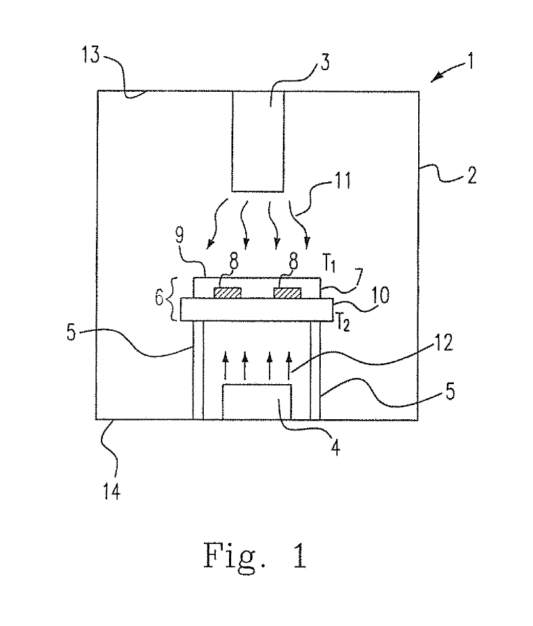

The structure of the wafer to be cured is schematically depicted as shown in FIG. 1. For instance, a wafer 6 includes a carrier 10 made of glass, a plurality of dies 8 connected on the surface of the carrier 10, and a molding compound 9 surrounding the dies 8. The carrier 10 may be of a type including, but not limited to, a wire bonding substrate, a chip scaled packaging (CSP) substrate, a wire bonding CSP substrate, a flip chip BGA (FCBGA) substrate, a window BGA substrate and on the like. The glass may be of a type including, but not limited to, fuse silica/quartz glass, soda lime glass, white glass, alkaline-free glass, BOROFLOAT® 33 glass (SCHOTT), D 2630 T eco glass (SCHOTT), PYREX® 7740 (CORNING) glass, silicon glass, and on the like. Other than glass, silicon and copper are also available as materials for the carrier. The types of molding compound materials for packaging the dies include, but are not limited to, epoxy (polyepoxide), filler (SiO₂), dryfilm, ajinomoto build-up film, and the like.

In the VFM process, the cavity magnetron of the conventional VFM device converts high-voltage electric energy to microwave radiation and simultaneously radiates to heat the wafer, and the glass carrier expands/shrinks with the dramatically high temperature, leading to no rectification in wafer warpage. After the molding process, in which the wafer may become warped, the molding compound needs to be fully cured. Less warpage of the wafer 10 after full curing of the molding compound is desired. Otherwise, subsequent semiconductor manufacturing processes, such as a redistribution layer (RDL) process, and the reliability tests, will be adversely affected.

Please refer to FIG. 1, which depicts an embodiment of a VFM device 1 in accordance with the present disclosure. In the VFM device 1, a heater 3, e.g. a cavity magnetron, is disposed in the top wall 13 of a device body 2, and a cooler 4 is disposed in proximity to the bottom wall 14 of the device body 2. That is, the cooler 4 can be disposed on, in, or under the bottom wall 14 of the chamber 2. Furthermore, the VFM device 1 further includes a support 5 to carry or support a wafer 6 and is usually connected to the bottom wall 14. The support 5 can be configured as any conformation/structure to adapt to the size/height/weight of the wafer 6, and can be disposed on the side wall of the chamber or the top wall 13 thereof, if desired. Alternatively, a rotary carrier for rotating the curing wafer can be another type of the carrier. The wafer to be cured is described as aforementioned and shown in FIG. 1. Upon rectifying warpage of the wafer 6, the heater 3 radiates microwave and heat (arrow 11 indicates the flow of heat) and causes a relatively high temperature in the first layer 7 (including dies and the molding compound) of the wafer 6, so that the temperature T₁ of the first layer 7 is close to about 200° C., for example. In addition, the cooler 4 conducts an endothermic reaction to coot the carrier 10 (or the second layer of the wafer 6) preventing the glass from the uncontrollable expansion or shrinkage. For instance, a cold air flow (indicated by arrow 12) or a relatively-low-temperature air flow is transmitted from the cooler 4 to the carrier 10 to make the temperature T₂ of carrier 10 be about 40° C. to 50° C. That is, the upper layer 7 of the wafer 6 has a temperature about equal to the temperature T₁, and the lower layer 10 thereof maintains its temperature at the temperature T₂, so that the wafer 6 is selectively heated. Since the temperature T₁ of the wafer 6 is significantly higher than the temperature T₂ of the carrier 10, the wafer 6 is subject to significant temperature variation, and the warpage of the wafer 6 can be rectified.

Furthermore, the temperature of the first layer 7 and the carrier 10 in the ambient atmosphere before rectification may be about 25° C. The change in temperature T₁ is formulated as “ΔT₁=T₁=25° C.” and the change in temperature T₂ is formulated as “ΔT₂=T₂−25° C.” accordingly. In accordance with various embodiments, not only is the temperature T₁ of the first layer 7 significantly higher than the temperature T₂ of the carrier 10, but also the change in temperature ΔT₁ of the first layer 7 is significantly higher than the change in temperature ΔT₂ of the carrier 10. Since the coefficient of thermal expansion of an article is proportional to the change in temperature, the conformation of the molding compound 7 will be influenced by the changes in temperature ΔT₁, and thus the wafer warpage will be rectified by the configuration and operation of the WFM device in the present disclosure.

In addition, since the warped wafer has been processed with the molding compound, the temperature difference present in the glass/silicon substrate is less than that in the molding compound after rectification, and thus the glass shrinkage caused by the temperature difference will be reduced.

For providing the cold air flow, the cooler 4 can be configured as an air cooling device, and includes but is not limited to any of a ventilator, a fan, a cooling plate, an air conditioner, a fin heat sink and a combination thereof. The cooling device 6 can also be configured as a water cooling device, such as a looped heat pipe system, a condenser, other apparatuses and the like.

In an example, the temperature T₁ is higher than the temperature T₂, and the temperature T₁ has any value in a range of about 100° C. to about 200° C., or in a range of about 150° C. to about 160° C., or up to 265° C. (a temperature monitored by the VFM device), for instance. Since increasing the curing temperature is beneficial in reducing the curing time, the number of wafers per hour (WPH) is increased.

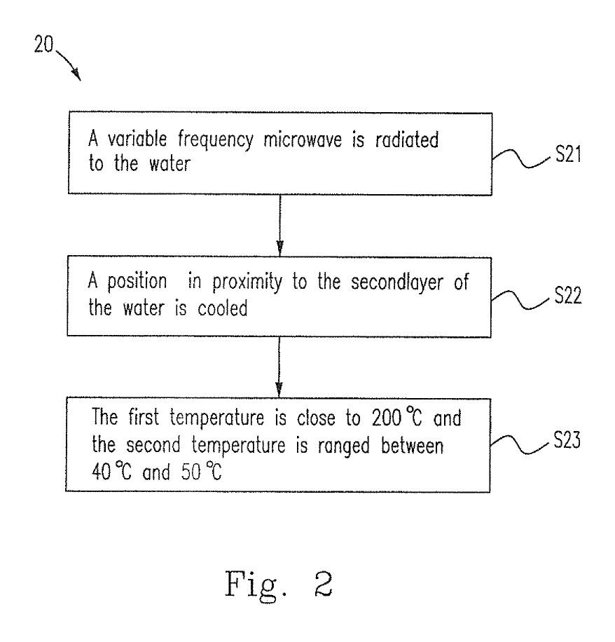

Please refer to FIG. 2, which depicts a method 20 for rectifying wafer warpage in accordance with the present disclosure. The wafer includes a first layer and a second layer as described above. In step S21, the variable frequency microwave is radiated to the first layer. Furthermore, in step S22, a position in proximity to the second layer of the wafer is cooled. The variable frequency microwave is radiated from an aforementioned VFM device. Step S22 can be performed by an endothermic reaction via a cooling device or other exemplary apparatuses. During the process of steps S21 and S22, the first temperature of the first layer of the wafer is close to about 200° C. and the second temperature of the second layer thereof is in a range between about 40° C. and about 50° C., for example (Step S23). Thus, the first layer of the wafer has a first temperature difference calculated by the formula “the first temperature (° C.)−about 25° C.”, the second layer thereof has a second temperature difference calculated by the formula “the second temperature (° C.)−about 25° C.”, and the coefficient of thermal expansion of wafer can be determined accordingly. Since there is the significant high temperature at the first layer (containing dies and molding) and the low temperature at the second layer (i.e. the glass carrier), wafer warpage is fully rectified and expansion/shrinkage is avoided in the glass carrier.

To sum up, wafer warpage or wafer bowing can be rectified and cured by the VFM device and the rectifying method of the present disclosure, and WPH is correspondingly increased. The design of the VFM device and the rectifying method of the disclosure offer advantages for semiconductor fabricating processes. Based on the concept/spirit of the present disclosure, the heat from two different heat sources can be applied on the article at a heating device with an adequate time period to enable the article to have two or more temperatures or temperature differences/gradients to cure the warpage or bends of the articles.

In accordance with various embodiments, a variable frequency microwave (VFM) device includes a chamber including top and bottom walls; a heater installed in the top wall of the chamber; and a cooler installed in proximity to the bottom wall of the chamber.

In accordance with various embodiments, a VFM device is provided and includes a chamber including a bottom wall; and a cooling device installed in proximity to the bottom wall.

In accordance with various embodiments, a method of rectifying warpage of a wafer is provided, the wafer includes a first layer and a second layer, and the method includes: providing a variable frequency microwave to the first layer; and cooling a position in proximity to the second layer of the wafer.

While the disclosure has been described in terms of what is presently considered to be the most practical and preferred Embodiments, it is to be understood that the disclosure needs not be limited to the disclosed Embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A variable frequency microwave (VFM) device comprising:
a chamber including top and bottom walls;
a heater installed in the top wall of the chamber; and
a cooler installed in proximity to the bottom wall of the chamber.

2. The VFM device according to claim 1, wherein the VFM device further comprises a support for supporting a wafer comprising a first layer having a first temperature caused by the heater and a second layer having a second temperature caused by the cooler.

3. The VFM device according to claim 2, wherein the first layer has a first temperature difference, the second layer has a second temperature difference, the first temperature difference is calculated by subtracting about 25° C. from the first temperature, and the second temperature difference is calculated by subtracting about 25° C. from the second temperature.

4. The VFM device according to claim 2, wherein the first temperature is about 200° C. and the second temperature is in a range from about 40° C. to about 50° C.

5. The VFM device according to claim 2, wherein the second layer is made of a first material being one selected from a group consisting of a glass, a silicon and a copper, and the first layer comprises a plurality of dies connected to the second layer and a molding compound surrounding the plurality of dies.

6. The VFM device according to claim 5, wherein the molding compound is made by a second material being one selected from a group consisting of an epoxy, a filler, a dryfilm and an adjinomoto build-up film.

7. The VFM device according to claim 2, wherein the first layer has an upper surface and a lower surface, and the upper surface has the first temperature and the lower surface has a third temperature between the first temperature and the second temperature.

8. The VFM device according to claim 1, wherein the cooler conducts an endothermic reaction to cool the carrier.

9. The VFM device according to claim 1, wherein the cooler is one of an air cooling device and a water cooling device.

10. The VFM device according to claim 9, wherein the air cooling device is selected from a group consisting of a ventilator, a fan, a cooling plate, an air conditioner and a fin heat sink.

11. The VFM device according to claim 9, wherein the water cooling device is one of a loop heat pipe system and a condenser.

12. A variable frequency microwave (VFM) device comprising:
a chamber including a bottom wall; and
a cooling device installed in proximity to the bottom wall.

13. The VFM device according to claim 12, wherein the VFM device further comprises a heater to radiate a microwave to heat a wafer with a first temperature, and the cooling device cools the bottom wall to a second temperature.

14. The VFM device according to claim 13, wherein the first temperature is higher than the second temperature, and is in a range between about 100° C. and about 200° C.

15. The VFM device according to claim 13, wherein the first temperature is higher than the second temperature, and is in a range between about 150° C. and about 160° C.

16. A method of rectifying warpage of a wafer, the wafer comprising a first layer and a second layer, the method comprising:
providing a variable frequency microwave to the first layer; and
cooling a position in proximity to the second layer of the wafer.

17. The method according to claim 16, wherein the first layer includes plural dies and a molding compound, the second layer is made of a glass, and the variable frequency microwave is radiated from a variable frequency microwave device.

18. The method according to claim 16, wherein the first layer has a first temperature and a first temperature difference, the second layer has a second temperature and a second temperature difference, the first temperature difference is calculated by subtracting about 25° C. from the first temperature, and the second temperature difference is calculated by subtracting about 25° C. from the second temperature.

19. The method according to claim 18 further comprising a step of causing the first temperature to be close to 200° C. and the second temperature to be in a range of about 40° C. to about 50° C.

20. The method according to claim 16, wherein the cooling step is performed via a cooling device.
